(19) United States
(12) Patent Application Publication
(10) Pub. No.: US 2018/0027605 A1
(43) Pub. Date: Jan. 25, 2018

(54) Method, System and Devices for Connecting a User Equipment, UE, to a Telecommunication Network

(71) Applicant: Telefonaktiebolaget LM Ericsson (publ), Stockholm (SE)

(72) Inventors: Samuel Axelsson, Linköping (SE); Andreas Bergström, Vikingstad (SE); Fredrik Gunnarsson, Linköping (SE); Sofia Svedevall, Brokind (SE)

(21) Appl. No.: 15/549,934

(22) PCT Filed: Feb. 12, 2015
(86) PCT No.: PCT/EP2015/052997

§ 371 Date: Aug. 9, 2017

(51) Int. Cl. H04W 76/04; H04W 76/06; H04W 76/02

(52) U.S. Cl. CPC H04W 76/04; H04W 76/02; H04W 76/06

(57) ABSTRACT

Method of connecting a user equipment, UE, to a telecommunication network via an access node comprised in said network, said method comprising the steps of receiving, by said access node, a connection request from said UE, determining, by said access node, connection configuration parameters for said UE, comprising checking whether connection configuration parameters for said UE related to a prior connection between said UE and said telecommunication network are available for re-use, and connecting, by said access node, said UE to said telecommunication network via said access node by setting up said determined connection configuration parameters for said U E.

### TECHNICAL FIELD

The present invention generally relates to a method of connecting a User Equipment, UE, to a telecommunication network via an access node comprised by the network, and, more specifically, to method steps performed to determine connection configuration parameters for the UE.

### BACKGROUND

In case a User Equipment, UE, intends to connect to a telecommunication network, it will send a connection request message to an access node comprised by the network. This access node is a Radio Base Station, RBS, also known as eNodeB, depending on the technology applied. Upon receipt of such a connection request message, connection configuration parameters are determined by a connection management function for determining specific settings for the (wireless) connection between the UE and the access node.

Such connection configuration parameters may relate to a variety of settings, although they all relate to the physical or logical connection between the UE and the telecommunication network, or more precise between the UE and the access node. Here below, examples of such connection configuration parameters and a short summary of the content of these parameters are provided.

In order to increase capacity in the telecommunication network, an operator may decide to deploy cells on multiple frequency layers, referred to as carriers. Load balancing is a known technique to balance the traffic load between overlaid cells in the network in order to utilize the capacity on the different frequency layers. Connection configuration parameters may therefore comprise load balancing parameters for, for example, indicating the load in each cell, or which cells are overlaid, etc.

Another example of connection configuration parameters relates to carrier aggregation. A UE may be arranged for transmitting and/or receiving data via more than one frequency layer or carrier from the same or a different access node. In case a UE is capable of supporting such functionality, multiple carriers may be aggregated such that the UE is provided with wider transmission bandwidths.

Dual Connectivity is another example of a connection configuration parameter. It enables the establishment of user plane connections via another access node, referred to as a secondary access node, while maintaining higher layer connection management via a master access node. This means that a UE may have user plane connections completely via the master or primary access node, or split between the master access node and the secondary access node.

A further example of a connection configuration parameter is related to unlicensed carrier operation. In case unlicensed carrier operation is applicable, some criteria have to be met in order to co-exist with other (licensed or un-licensed) connections in the same frequency bands. The connection configuration parameters may then be related to these criteria.

An example of deployment of radio base station antennas is via flexible multi-element antennas. These antenna elements can be configured to combine in such a way that the transmitted energy, or receiver sensitivity, becomes directional, i.e. like a beam. The configuration parameters of these multiple-element antennas for creating such a directional beam may be comprised by the connection configuration parameters.

Based on the above, it is clear that complex configurations, i.e. connection configuration parameters, need to be determined by the connection management function once a connection request message from the UE has been received by the access node. Determining these connection configuration parameters may further involve signalling further nodes, for example core telecommunication network nodes, for obtaining connection information to be used for determining the actual connection configuration parameters.

The process of determining these complex configurations is considered to be time consuming, to take up many resources, i.e. increases the load of the telecommunication network, and to be relatively imprecise.

### SUMMARY

It is an object of the present invention to provide for an improved method of connecting a User Equipment, UE, to a telecommunication network via an access node comprised in the network, such that the process of determining the connection configuration parameters is made more efficient. The access node is a Radio Base Station, RBS, also known as eNodeB, depending on the technology applied.

It is another object to provide for an access node arranged for connecting a UE to a telecommunication network, wherein the access node is arranged for efficiently determining and setting the connection configuration parameters for the UE.

It is a further object to provide for an improved UE arranged for requesting reconnection to a telecommunication network via an access node comprised in the network, in such a way that the connection configuration parameters for the UE are efficiently determined.

In a first aspect of the invention there is provided a method of connecting a user equipment, UE, to a telecommunication network via an access node comprised in said network, said method comprising the steps of:

receiving, by said access node, a connection request from said UE;

determining, by said access node, connection configuration parameters for said UE, comprising checking whether connection configuration parameters for said UE related to a prior connection between said UE and said telecommunication network are available for re-use;

connecting, by said access node, said UE to said telecommunication network via said access node by setting up said determined connection configuration parameters for said UE.

The method is based on the insight that connection configuration parameters for the UE related to a prior connection between the UE and the telecommunication network may already be available such that these parameters can be re-used for the UE.

In case connection configuration parameters related to a prior connection are already known in the telecommunication network, it is no longer needed for the access node to determine the complex configuration, i.e. the connection configuration parameters, for the UE, as the parameters can be re-used. The process of determining the connection configuration parameters is therefore made very simple, as the connection configuration parameters are already known from a prior connection between the UE and the telecommunication network. The method thus takes up fewer resources, i.e. it decreases the load of the telecommunication network compared to the conventional method for determining these connection configuration parameters.

By re-using known connection configuration parameters for the UE, the initial UE configuration can be made UE specific which means that a UE specific configuration can be adopted much faster compared to using a general purpose initial configuration. Furthermore, measurement configurations and feedback can be tailored to the initial UE specific situation which enables more efficient resource utilization.

According to the present invention, not all available connection configuration parameters need to be re-used for a particular UE. In order to obtain the advantages of the method, it is sufficient when at least one available connection configuration parameter is re-used, or when the connection configuration parameters for the UE are determined using the available connection configuration parameters as an input for the determination process. In the latter, using the available connection configuration parameters in the determination process ensure that the determination process quickly converges to a UE specific configuration.

Typically, the connection configuration parameters are directed to the settings of the specific physical or logical wireless connection between the UE and the access node to which it connects.

The available connection configuration parameters are directed to a prior connection between the UE and the telecommunication network, i.e. they may be directed to the connection of the UE to the same access node, but can also be directed to the connection of the UE to a different access node comprised in the same telecommunication network.

According to the present invention, the telecommunication network may comprise any of a Long Term Evolution, LTE, network, an Evolved Packets System, EPS, network, a Universal Mobile Telecommunications System, UMTS, network and a General Packet Radio Service, GPRS, network.

In an example, the method further comprises the step of:
upon detection of a released connection between said UE and said telecommunication network via said access node, storing said connection configuration parameters such that said connection configuration parameters are available, for re-use, when said access node receives a further connection request from said UE.

The advantage of this example is that it is ensured that the connection configuration parameters are made available for the UE in case the UE intends to reconnect to the telecommunication network, for example via the same access node. This will make sure that the latest, and thus also the most promising, connection configuration parameters are available for the UE during reconnection to the telecommunication network.

The key concept of this example is that connection configuration parameter for a UE are stored once the UE moves from a connected mode to an idle mode, i.e. when the UE is released from the telecommunication network. As such, the connection configuration parameters are saved between sessions of the same UE to the same telecommunication network.

In order to detect a released connection, the telecommunication network, or the access node, may monitor the UE data buffers. In case the UE data buffers are empty for a certain time period, the UE is actively released from the telecommunication network by, for example, signalling messages to the UE.

Another possibility of detecting a released connection is detecting that the connection is suddenly lost, for example during an error case or the like. The telecommunication network, or more specifically the access node, is able to detect such a situation as the UE is no longer responding to any messages sent to that UE. In such a situation, the access node may consider that the connection between the UE and the access node is lost, and will then store the connection configuration parameters related to the last known configuration for that UE.

In a more detailed example hereof, the step of storing further comprises any of the steps:

storing, by said UE, said connection configuration parameters in relation to said access node;

storing, by said access node, said connection configuration parameters in relation to said access node and said UE;

forwarding, by said access node, said connection configuration parameters to, and storing said connection configuration in relation to said access node and said UE by a control function residing in, a control node comprised in said telecommunication network.

In case the connection configuration parameters are stored by the UE, as disclosed above, then the detection of the released connection between the UE and the telecommunication network may also be performed by the UE. Next time the UE intends to reconnect to the same telecommunication network, it will send a connection request message to any of the access nodes comprised in the telecommunication network but it will also provide the telecommunication network, for example the access node, with its stored connection configuration parameters such that these parameters are made available in the telecommunication network.

The connection configuration parameters may also be stored in a memory of the access node, or in the memory of any control node comprised in the telecommunication network. In the latter, the access node, or the UE, needs to signal the connection configuration parameters to the control node, and it thus also needs to request the control node for available connection configuration parameters in case a UE intends to connect to the telecommunication network.

In a further detailed example, said connection configuration parameters in relation to said access node are stored by said UE, said method further comprising the step of:
providing, by said UE, said connection configuration parameters in relation to said access node, to said access node.

In yet another example, no connection configuration parameters for said UE related to a prior connection between said UE and said telecommunication network are available for re-use, and wherein said step of determining comprises:
determining connection configuration parameters for said UE based on available connection configuration parameters between a plurality of UE and said access node.

The inventors noted that, in case no connection configuration parameters are available for the UE, it may be beneficial to take into account the available connection configuration parameters for other UE's when determining the actual connection configuration parameters for the UE that intends to connect to the telecommunication network. The available connection parameters may then be used to provide for a reasonable estimate on what connection configuration parameters the UE that intends to connect shall be set or initiated with.

The connection configuration parameters may comprise any of, but not limiting to the list of:

frequency carrier aggregation configuration via licensed and unlicensed frequency bands;

dual connectivity configuration;

antenna beam configuration;

uplink timing configuration;

history of need for and utilization of secondary carriers;

geographical information;

aggregated frequency bands;

aggregated bandwidth, and

measurement and feedback configuration.

Frequency carrier aggregation configuration via licensed and unlicensed bands may entail that a carrier in licensed band that was configured as secondary carrier in the available connection configuration parameters is set in the same way in the new session, i.e. the connection between the UE and the access node. This may also depend on the load situation at different carriers, such that none, some or all of the previously configured carriers are configured for the current session. The same is valid for carriers in unlicensed bands.

Dual connectivity configuration within the same or across radio access technologies may entail that a secondary access node at the same radio access technology that was configured as a secondary access node in the available connection configuration parameters is configured in the same way in the new session. This may also depend on the load situation at different carriers at the secondary access node, so none, some or all of the previously configured secondary base stations are configured for the new session.

Antenna beam configurations may entail that an antenna element configuration in the available connection configuration parameters is configured in the same way for the new connection between the UE and the telecommunication network.

History of need for and utilization of secondary carriers may comprise which fraction of time the additional configurations have been used, fraction of resources used at the primary configuration and resources used at the additional configurations, what performance were observed for the additional configuration and the need to change connection configuration during previous connections.

The history of need for and utilization of secondary carriers may, for example, be used to decide when it's better to use an initial configuration, i.e. an initial set of connection configuration parameters, instead of using the yet available connection configuration parameters related to a prior connection between the UE and the telecommunication network, as the initial configuration. For example, if it is clear that the available connection configuration parameters did not lead to satisfactory performance results for the UE, it may be decided to use an initial set of connection configuration parameters instead.

The geographical information may comprise cell identity, tracking area identity, Global Navigation Satellite System, GNSS, measurements, estimated angle from the access node to the UE, estimated range from the access node to the UE and an estimated fingerprint, which basically is a set of measurements from serving and non-serving cells, comprising signal strength measurements, range measurements, etc.

In an example, connection configuration parameters for said UE related to said prior connection between said UE and said telecommunication network are available for re-use, wherein said step of determining comprises:

determining said connection configuration parameters based on said available connection configuration parameters, and any of:
performance parameters achieved by said connection configuration parameters related to said prior connection between said UE and said telecommunication network;
load situation at different carriers;
present geographical information of said UE and geographical information of said UE during said prior connection between said UE and said telecommunication network.

In order to efficiently determine the connection configuration parameters for the UE, the inventors found that in some situation it may not be beneficially to re-use all the available connection configuration parameters for that UE. The connection configuration parameters may then be used as an input for determining the new connection configuration parameters. It was a further insight of the inventors that the validity, applicability, or the probability that all the connection configuration parameters can be re-used may at least partly depend on any of the performance parameters achieved by the connection configuration parameters related to the prior connection between the UE and the telecommunication network, load situation at different carriers and geographical information of the UE and geographical information of the UE during the prior connection between the UE and the telecommunication network.

According to the present invention, the access node may be any of a radio base station and an eNodeB, or a node having a control function which provides functionality of any of a Mobility Management Entity, MME, and an Access Network Discovery and Selection Function Server, ANDSF-server.

In a second aspect of the invention, there is provided a method of requesting reconnection, by a User Equipment, UE, to a telecommunication network via an access node comprised in said network, wherein said UE is connected to said access node by set connection configuration parameters, said method comprising the steps of:

upon detection, by said UE, of a released connection between said UE and said telecommunication network via said access node, storing, by said UE, said connection configuration parameters in relation to said access node;

requesting, by said UE, reconnection to said telecommunication network via said access node by providing, by said UE, said access node with said stored connection configuration parameters.

The inventors noted that, in order to enable an access node to determine whether connection configuration parameters are available for a specific UE, these connection configuration parameters may be provided to the access node by the specific UE itself. Each time the UE detects a released connection between itself and the telecommunication network, it may store the last known connection configuration parameters. In case the UE intends to reconnect to the same telecommunication network, it may request reconnection to the telecommunication network via an access node, and it should provide that access node with the stored connection configuration parameters. Based on the provided connection configuration parameters, the access node may decide to re-use them all, or to use the provided parameters as an input for the determination process.

In a third aspect of the present invention, there is provided an access node arranged for connecting user equipment, UE, to a telecommunication network, said telecommunication network comprising said access node, said access node comprising:

receiving equipment arranged for receiving a connection request from a User Equipment, UE.

determining equipment arranged for determining connection configuration parameters for said UE, at least by checking whether connection configuration parameters for said UE related to a prior connection between said UE and said telecommunication are available for re-use;

connecting equipment arranged for connecting said UE to said telecommunication network by setting said determined connection configuration parameters.

The access node may comprise a processor and a memory, wherein the memory comprising instructions executable by the process, whereby the location server is operative to perform any of the method steps directed to the access node, as disclosed with the examples provided above.

In the context of the present invention, a module, device, equipment, or the like may also be implemented as a computer program running on the processor.

The expressions, i.e. the wording, of the different aspects comprised by the access node according to the present invention should not be taken literally. The wording of the aspects is merely chosen to accurately express the rationale behind the actual function of the aspects.

In accordance with the present invention, different aspects applicable to the above mentioned examples of the method, including the advantages thereof, correspond to the aspects which are applicable to the access node according to the present invention.

In an example, the access node may comprise:

detection equipment arranged for detecting a released connection between said UE and said telecommunication network, and

storing equipment arranged for storing said connection configuration parameters, upon detecting of a released connection between said UE and said telecommunication network, such that said connection configuration parameters are available, for re-use, when said access node receives a further connection request from said UE.

In yet another example, the storing equipment is further arranged for forwarding said connection configuration parameters to a control node comprised in said telecommunication network for storing said connection configuration in relation to said access node and said UE in said control node.

In a further example, no configuration parameters for said UE related to a prior connection between said UE and said telecommunication network via said access node are available for re-use, wherein said determining equipment is further arranged for:

determining connection configuration parameters for said UE based on available connection configuration parameters between a plurality of UE and said access node.

In an example hereof, the connection configuration parameters comprises any of:

frequency carrier aggregation configuration via licensed and unlicensed frequency bands;

dual connectivity configuration;

antenna beam configuration for said access node;

uplink timing configuration;

aggregated frequency bands;

aggregated bandwidth;

history of need for, and utilization of, secondary frequency carrier configuration.

In a further example, connection configuration parameters for said UE related to said prior connection between said UE and said telecommunication network via said access node are available for re-use, wherein said determining equipment is further arranged for:

determining said connection configuration parameters to be said available connection configuration parameters.

In a fourth aspect of the invention, there is provided a User Equipment, UE, arranged for requesting reconnection to a telecommunication network via an access node comprised in said network, wherein said UE is connected to said access node by set connection configuration parameters, said UE comprising:

detection equipment arranged for detecting a released connection between said UE and said telecommunication network via said access node,

storing equipment arranged for storing said connection configuration parameters, upon detecting of a released connection between said UE and said telecommunication network, and

requesting equipment arranged for requesting reconnection to said telecommunication network via said access node by providing said access node with said stored connection configuration parameters.

In a fifth aspect of the invention, there is provided a non-transitory computer-readable storage medium, comprising instruction which, when executed on at least one processor, cause the at least one processor to carry out the method according to any of the examples provided above.

In a sixth aspect of the invention, there is provided a telecommunication network arranged for connecting a User Equipment, UE, to an access node comprised in said network, wherein said access node comprises:

receiving equipment arranged for receiving a connection request from a User Equipment, UE.

determining equipment arranged for determining connection configuration parameters for said UE, at least by checking whether connection configuration parameters for said UE related to a prior connection between said UE and said telecommunication network are available for re-use;

connecting equipment arranged for connecting said UE to said telecommunication network by setting said determined connection configuration parameters.

In a seventh aspect of the invention, there is provided for an access node for connecting user equipment, UE, to a telecommunication network, said telecommunication network comprising said access node, said access node comprising:

receiving module for receiving a connection request from a User Equipment, UE.

determining module for determining connection configuration parameters for said UE, at least by checking whether connection configuration parameters for said UE related to a prior connection between said UE and said telecommunication network are available for re-use;

connecting module for connecting said UE to said telecommunication network by setting said determined connection configuration parameters.

In an eighth aspect of the invention, there is provided a User Equipment, UE arranged for requesting reconnection to a telecommunication network via an access node comprised in said network, wherein said UE is connected to said access node by set connection configuration parameters, said UE comprising:
detection module for detecting a released connection between said UE and said telecommunication network via said access node,
storing module for storing said connection configuration parameters, upon detecting of a released connection between said UE and said telecommunication network, and
requesting module for requesting reconnection to said telecommunication network via said access node by providing said access node with said stored connection configuration parameters.

The above-mentioned and other features and advantages of the invention will be best understood from the following description referring to the attached drawings. In the drawings, like reference numerals denote identical parts or parts performing an identical or comparable function or operation.

### BRIEF DESCRIPTION OF THE DRAWINGS

FIG. 1 is a schematic diagram illustrating an embodiment of the method steps;

FIG. 2 is a schematic diagram illustrating an embodiment of the network;

FIG. 3 is a schematic diagram illustrating an embodiment of the network;

FIG. 4 is a signalling diagram illustrating an exchange of signals in an embodiment of the method;

FIG. 5 is a signalling diagram illustrating an exchange of signals in an embodiment of the method;

FIG. 6 is a signalling diagram illustrating an exchange of signals in an embodiment of the method;

FIG. 7 is a block diagram illustrating an embodiment of an access node;

FIG. 8 is a flow chart illustrating an embodiment of method steps;

FIG. 9 is a block diagram illustrating an embodiment of a User Equipment.

### DETAILED DESCRIPTION

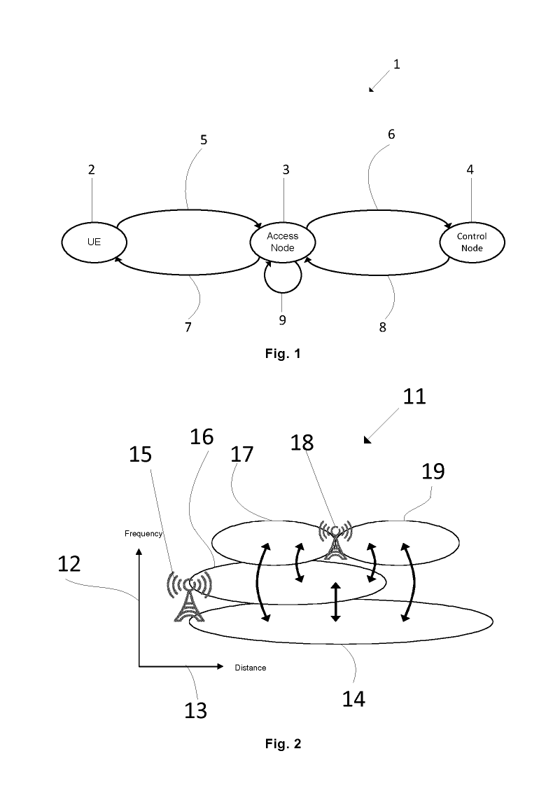

FIG. 1 is a schematic diagram 1 illustrating an embodiment of the method steps. Here, a User Equipment, UE 2, intends to connect to a telecommunication network comprising at least an access node 3. The network may further comprise a control node 4. This access node 3 is a Radio Base Station, RBS, also known as eNodeB, eNB, depending on the technology applied.

The UE 2 transmits 5 a connection request message towards an access node 3 comprised in the telecommunication network. The access node 3 may be any of a radio base station or an eNodeB, or may comprise a control function providing functionality of a mobility management entity and an access network discovery and selection function server. Upon receipt of the connection request message, the access node needs to determine whether the UE 2 is allowed to gain access to the telecommunication network, and, if so, needs to determine and set connection configuration parameters for the UE 2.

These connection configuration parameters may relate to the wireless connection between the UE 2 and the access node 3, for example Physical layer parameters, Medium Access Layer, MAC, parameters or the like.

In order to determine these connection configuration parameters for the UE 2, the access node 3 informs 6 or requests a control function, located in e.g. the control node 4 whether connection configuration parameters related to a prior connection between that specific UE 2 and the same telecommunication network are already available. These connection configuration parameters may have been stored previously, by the control node, once it had been detected that the prior connection between the UE 2 and the telecommunication network had been released.

The access node 3 may provide the control node 4 with the International Mobile Subscriber Identity, IMSI, of the UE, or any other unique identifier for uniquely identifying the UE 2. Based on the provided identifier, the control node 3 is able to uniquely retrieve the associated connection configuration parameters for that UE 2, for example, from a database comprised in an internal memory of the control node 4. The retrieved connection configuration parameters may then be transmitted 8 to the access node 3.

The access node 3 will then, subsequently, determine and set the connection configuration parameters for the UE 2 based on the received available connection configuration parameter from the control node 4, and based on auxiliary information.

The auxiliary information may be directed to the accuracy, validity of the available connection configuration parameters for re-use, and may comprise performance parameters achieved by said connection configuration parameters related to said prior connection between said UE and said telecommunication network, load situation at different carriers, and present geographical information of said UE and geographical information of said UE during said prior connection between said UE and said telecommunication network.

Finally, the access node 3 transmits 7 a connection accept message to the UE 2, possibly comprising at least a subset of the determined connection configuration parameters, such that the UE 2 is able to set its device accordingly.

FIG. 2 is a schematic diagram 11 of radio base stations having overlapping cells 14, 16, 17, 19, wherein each cell is operative in a different frequency band/frequency layer. The vertical axis 12 indicates the frequency of the cells, and the horizontal axis 13 indicates the available distance of the different cells.

Here, each access node 15, 18, for example an evolved UMTS Terrestrial Radio Access Netowrk, E-UTRAN, eNodeB in an Long Term Evolution, LTE, telecommunication network, serves cells 14, 16, 17, 19 which may or may not overlap with each other. In the present example, the access nodes shown in FIG. 2, i.e. access nodes having reference numeral 15 and 18, respecitvely, are embodiments or specific implementations of the access node shown in FIG. 1 indicated with reference numeral 3.

Load balancing, being one of the connection configuration parameters for the UE 2, is a technique to balance the traffic load between the overlapping cells 14, 16, 17, 19 in the telecommunication network in order to utilize the capacity on the different frequency layers. Potential opportunities for load balancing are illustrated with arrows between the different cells 14, 16, 17, 19.

In order to perform load balancing, each access node 15, 18 assesses the traffic load in its cells 14, 16, 17, 19. The traffic load information is then exchanged between the cells, after which a load balancing algorithm identifies whether there is a need to handover UE's between the cells 14, 16, 17, 19 in order to balance the traffic load of each of the cells 14, 16, 17, 19. In case there is a need to handover UE's in order to balance the traffic load, the UE's are selected and ordered to a different cell in a known way.

Load balancing is thus a technique which the access nodes 15, 18, for example eNodeB's, can use to balance the traffic load in its cells 14, 16, 17, 19. A UE, requesting a particular service, can be ordered to a different cell, by any of the access nodes 14, 16, 17, 19, in case that different cell is also capable of providing that particular service to the UE. The different cell may be provided by the same access node, or by another access node, as long as the UE is covered by that different cell.

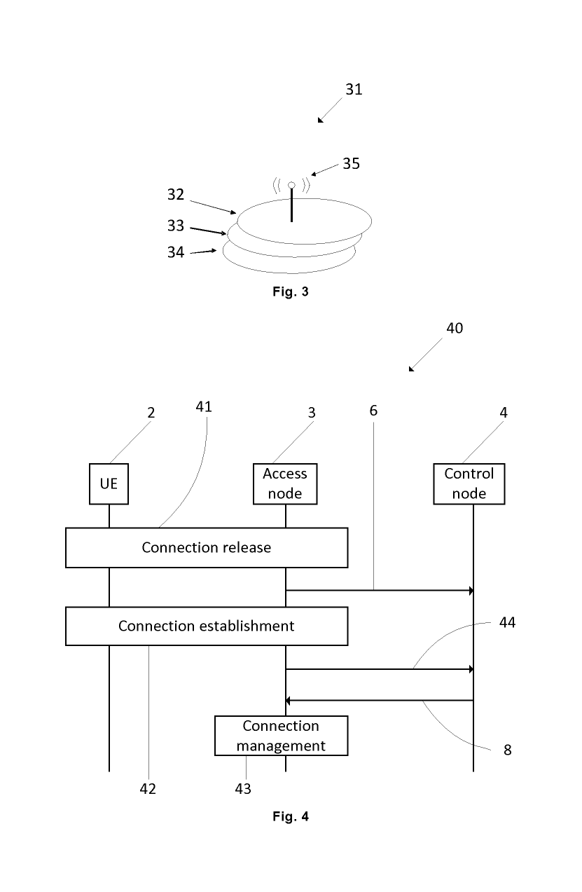

FIG. 3 is a schematic diagram 31 of cells 32, 33, 34 having approximately the same coverage area but deploying different frequencies. As mentioned before, a UE may be arranged to transmit and/or receive data via more than one frequency layer from the same access node 35.

In the present example, the access node shown in FIG. 3, i.e. access node having reference numeral 35 is an embodiment or a specific implementation of the access node shown in FIG. 1 indicated with reference numeral 3.

It is possible to deploy several cells 32, 33, 34 with approximately the same coverage area in case multiple frequency layers are available to the access node 35. Each of the multiple frequency layers are, in the art, referenced to as Component Carriers, CC.

Carrier Aggregation, CA, being information comprised by the connection configuration parameters, two or more of such Component Carriers are aggregated in order to support wider transmission bandwidths for the UE. The UE may then simultaneously receive or transmit on one or multiple Component Carriers depending on the capability of the UE.

It is, for example, possible to configure a UE to aggregate a different number of Component Carriers originating from the same access node 35 and of possibly different bandwidths in the uplink and the downlink. The number of download and upload component carriers than can be configured depends on the download and upload aggregation capabilities of the UE and of the telecommunication network.

UE's capable of handling component carriers can indicate their capability to the access node 35 via Radio Resource Control, RRC, signalling, for example using a RRCConnectionReconfiguration message.

FIG. 4 is a signalling diagram 40 illustrating an exchange of signals in an embodiment of the method.

The nature of the access node 3, and the mechanisms associated to the storage and retrieval of the connection configuration parameters are different in various embodiments.

In the embodiment shown in FIG. 4, the connection configuration parameters are stored in a network node different from the access node 3. The connection configuration parameters are stored in a control node 4, for example a Mobility Management Entity, MME.

Upon detection that the connection has been released 41 between the UE 2 and the access node 3, for example actively released or lost by an error situation or the like, the connection configuration parameters of the UE 2 are to be stored, such that these parameters can be made available the next time the same UE 2 intends to connect to the telecommunication network.

Hereto, the access node 3 forwards 6 the connection configuration parameters, along with a unique identity of the UE 2, to a control node 4 comprised in the telecommunication network. The control node can be a MME arranged for storing connection configuration parameters of a plurality of UE's. The control node 4 may then store the connection configuration parameters, along with the unique identity of the UE 2, as well as a unique identifier of the serving access node 3.

At a later time instant, the UE 2 attempts to establish 42 a connection with the same access node 3, for example via a request message. The access node 3 then checks whether connection configuration parameters for that UE 2 are available, by requesting 44 these parameters at the control node. The request is accompanied with the unique identity of the UE 2, for example its IMSI.

Based on the received request 44, the control node retrieves the stored connection configuration parameters, and provides 8 these parameters to the access node 3. A connection management function 43 is then able to determine the exact connection configuration parameters based on the received, available, connection configuration parameters for that UE 2.

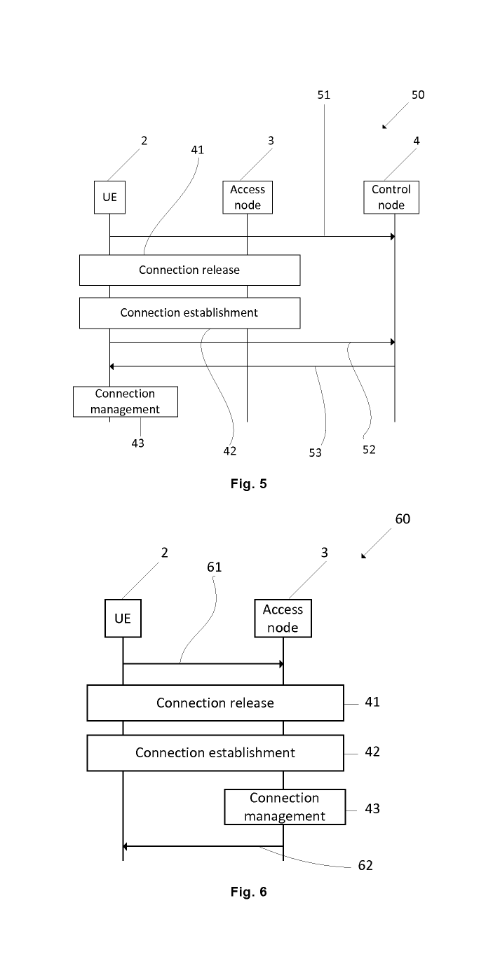

FIG. 5 is a signalling diagram 50 illustrating an exchange of signals in an embodiment of the method.

In this embodiment, the connection configuration parameters are stored in a network node different from the access node 3. The parameters are stored in the control node 4. The exchange of connection configuration parameters is thus between the UE 2 and the control node 4, via access node 3.

One example of such a control node, in the present example, is an Access Network Discovery and Selection Function Server, ANDSF server, which manages policies regarding how a UE 2 establishes connections and access to other radio access technologies such as WiFi. In such cases, the connection management 43 may be incorporated in the UE 2, supported by the control node 4.

Here, upon detection, by the UE 2, of a released connection 51, or just before actively releasing the connection, between said UE 2 and said telecommunication network via said access node 3, the connection configuration parameters are provided to the control node 4, by the UE 2 via access node 3. This will make sure that the most recent connection configuration parameters are made available to the control node 4.

Upon reconnection of the UE 2 to the same telecommunication network, for example via the same access node 3, using the block connection establishment 42, according to the present invention, it is checked whether connection configuration parameters for that UE 2 are already available in the ANDSF server in the telecommunication network.

To this end, the UE 2 signals 52 the control node 4 to request for the stored connection configuration parameters, and the control node 4 provides 53 said connection configuration parameters based on the request. In the present case, the connection management function 43 resides in the UE 2, which is then further supported by the access node 3.

FIG. 6 is a signalling diagram 60 illustrating an exchange of signals in an embodiment of the method.

In this embodiment, the access node 3 is the node that stores the connection configuration parameters. The access node 3 is a radio base station, for example an eNodeB, and it then also comprises functionality of a Mobility Management Entity, MME, or an Access Network Discovery and Selection Function Server, ANDSF-server.

Optionally, the UE will send 61 the connection configuration parameters to the access node 3 just before the connection is released 41. This step may not be required in case actual connection configuration parameter of the UE are already available to the access node 3.

When the UE 2 reconnects, or re-establishes the connection, i.e. in the connection establishment block 42, the connection management function 43 will retrieve or obtain the connection configuration parameters and use the information for connection management, which may comprise signalling 62 the connection configuration parameters to the UE 2.

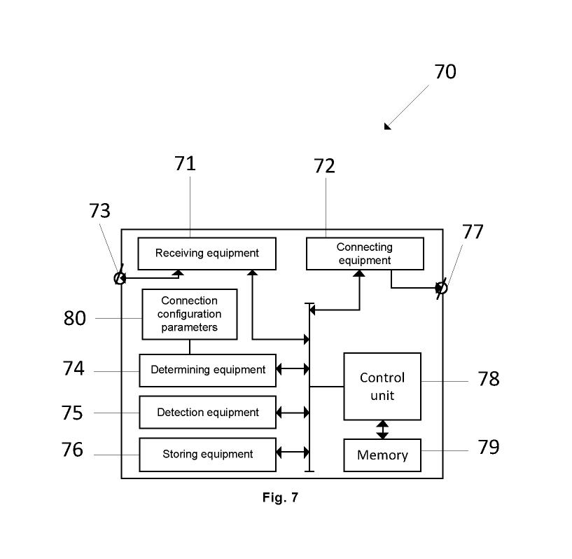

FIG. 7 is a block diagram illustrating an embodiment of an access node 3 arranged for connecting UE to a telecommunication network, wherein the telecommunication network comprises the access node 3.

The access node 3 comprises a control unit 78 and a memory 79, which control unit 78 is connected to a storing equipment 76, a detection equipment 75, a determining equipment 74, receiving equipment 71 and connecting equipment 72.

Incoming data packets or messages pass through the input terminal 73 before they reach the receiving equipment 71, or a receiving module. Outgoing data packets or messages pass or are sent by the connecting equipment 72, or a connecting module, via the output terminal 77, for example towards a UE 2, or a control node 4.

The receiving equipment 71 is arranged for receiving a connection request from a UE 2. The connection request may be a request message for access to the telecommunication network or the like, or may be a reconnection request message for reconnection to the same telecommunication network in case of a released or lost connection.

The determining equipment 74 is arranged for determining connection configuration parameters for the UE that intends to connect to the telecommunication network, at least by checking whether connection configuration parameters 80 for said UE 2 related to a prior connection between said UE 2 and said telecommunication are available for re-use.

The access node 3 further comprises connecting equipment 72 arranged for connecting 84 said UE 2 to said telecommunication network by setting said determined connection configuration parameters 80 for said UE 2.

In a more detailed example, the access node 3 further comprises detection equipment 75 arranged for detecting a released connection between said UE 2 and said telecommunication network, and storing equipment 76 arranged for storing 85 said connection configuration parameters 80, upon detecting of a released connection between said UE 2 and said telecommunication network, such that said connection configuration parameters 80 are available, for re-use, when said access node 3 receives a further connection request from said UE 2.

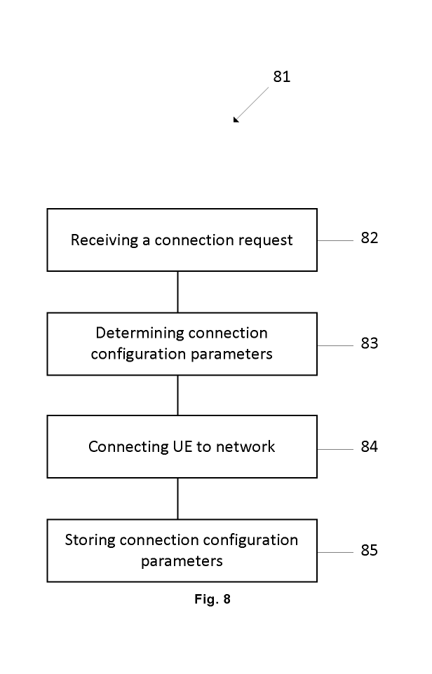

FIG. 8 is a flow chart 81 illustrating an embodiment of method steps.

The method steps comprise:
receiving 82, by said access node 3, a connection request from said UE 2;
determining 83, by said access node 3, connection configuration parameters 80 for said UE 2, comprising checking whether connection configuration parameters 80 for said UE 2 related to a prior connection between said UE 2 and said telecommunication network are available for re-use;
connecting 84, by said access node 3, said UE 2 to said telecommunication network via said access node 3 by setting up said determined connection configuration parameters 80 for said UE 2, and
storing 85, said connection configuration parameters in said telecommunication network.

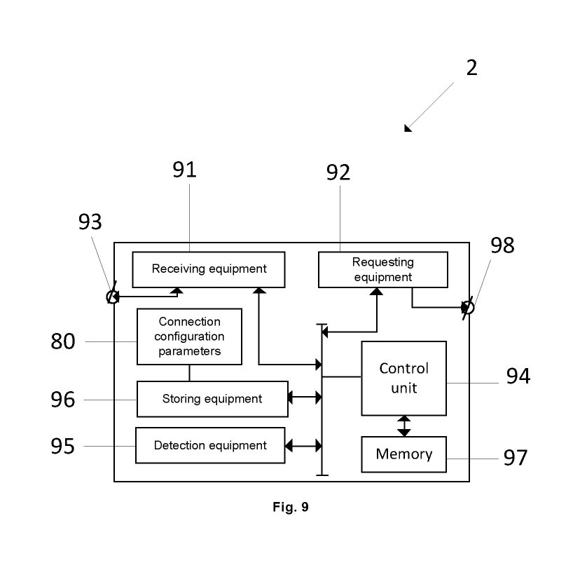

FIG. 9 is a block diagram illustrating an embodiment of a User Equipment, UE, 2 arranged for requesting reconnection to a telecommunication network via an access node comprised in the network, wherein the UE (2) is connected to the access node (3) by set connection configuration parameters (80).

The UE 2 comprises a control unit 94 and a memory 97, which control unit 94 is connected to a storing equipment 96, a detection equipment 95, a receiving equipment 91 and a requesting equipment 92.

Incoming data packets or messages pass through the input terminal 93 before they reach the receiving equipment 91, or a receiving module. Outgoing data packets or messages pass or are sent by the requesting equipment 92, or a requesting module, via the output terminal 98

The detection equipment (95) is arranged for detecting a released connection between said UE (2) and said telecommunication network via said access node (3), the storing equipment (96) is arranged for storing (85) said connection configuration parameters (80), upon detecting of a released connection between said UE (2) and said telecommunication network, and the requesting equipment (92) is arranged for requesting reconnection to said telecommunication network via said access node (3) by providing said access node (3) with said stored connection configuration parameters (80).

The core essence of the present invention is that connection configuration parameters for a UE, such as the configuration of primary carriers, secondary carriers, dual connectivity configurations, antenna beam configurations etc. can be maintained between different sessions relating to the same UE. This is achieved by, in an embodiment, storing the connection configuration parameters of the UE and making the connection configuration parameters available the next time the UE connects to the same telecommunication network.

Alternatively, parameters of a stored session of a particular UE can be used for other access requesting UEs having the same capability requirements.

An advantage of the present invention is that the connection configuration parameters are made available when the UE re-connects, and it allows the connection management functionality to re-use these parameters, for example, as a default configuration.

For a UE connecting for the first time, the history of other UEs, i.e. the available connection configuration parameters for other UEs, could be used as an initial estimate for suitable connection configuration parameters for the UE connecting for the first time.

In this way, the load that carrier aggregation usage and dual connectivity usage will introduce becomes more stable in cells and in access nodes It also makes processing more efficient in terms of signalling, CPU processing and simply in processing time as, for example, less combinations of load balancing, carrier aggregation and dual connectivity alternatives needs to be processed.

Reducing such alternatives are for example valuable when it comes to determining suitable secondary cell(s) and access node cell group(s) from coverage perspective since that typically involves measurements by the UE. Such measurements in turn involve signalling, potential need for measurement gaps, delays in taking connection management decisions etc.

All above benefits becomes even more valuable as UEs and telecommunication networks become more capable of carrier aggregation and dual connectivity in the near future, thereby increasing complexity of (re)-attachments.

Similar benefits can also be obtained by making use of the antenna beam configuration in this manner. Communication via antenna beams exploits the spatial dimension in the network, and the spatial conditions are likely to be similar for two consecutive sessions with the same UE.

The present invention is not limited to the embodiments as disclosed above, and can be modified and enhanced by those skilled in the art beyond the scope of the present invention as disclosed in the appended claims without having to apply inventive skills.

1-21. (canceled)

22. A method of connecting a User Equipment (UE) to a telecommunication network via an access node comprised in said network, said method comprising:
receiving, by said access node, a connection request from said UE;
determining, by said access node, connection configuration parameters for said UE, wherein said determining comprises checking whether connection configuration parameters for said UE related to a prior connection between said UE and said telecommunication network are available for re-use; and
connecting, by said access node, said UE to said telecommunication network via said access node by setting up said determined connection configuration parameters for said UE.

23. The method of connecting a UE to a telecommunication network of claim 22, further comprising the step of:
upon detection of a released connection between said UE and said telecommunication network via said access node, storing said connection configuration parameters such that said connection configuration parameters are available, for re-use, when said access node receives a further connection request from said UE.

24. The method of claim 23, wherein said storing comprises any of:
storing, by said UE, said connection configuration parameters in relation to said access node;
storing, by said access node, said connection configuration parameters in relation to said access node and said UE;
forwarding, by said access node, said connection configuration parameters to, and storing said connection configuration in relation to said access node and said UE by a control function residing in, a control node comprised in said telecommunication network.

25. The method of claim 24, wherein said connection configuration parameters in relation to said access node are stored by said UE, said method further comprising:
providing, by said UE, said connection configuration parameters in relation to said access node, to said access node.

26. The method of claim 22, wherein no connection configuration parameters for said UE related to a prior connection between said UE and said telecommunication network are available for re-use, and wherein said determining comprises:
determining connection configuration parameters for said UE based on available connection configuration parameters between a plurality of UEs and said access node.

27. The method of claim 22, wherein said connection configuration parameters comprise any of:
frequency carrier aggregation configuration via licensed and unlicensed frequency bands;
dual connectivity configuration;
antenna beam configuration;
uplink timing configuration;
history of need for and utilization of secondary carriers;
geographical information
aggregated frequency bands;
aggregated bandwidth, and
measurement and feedback configuration.

28. The method of claim 22, wherein connection configuration parameters for said UE related to said prior connection between said UE and said telecommunication network are available for re-use, wherein said determining comprises:
determining said connection configuration parameters to be said available connection configuration parameters.

29. The method of claim 22, wherein connection configuration parameters for said UE related to said prior connection between said UE and said telecommunication network are available for re-use, wherein said determining comprises:
determining said connection configuration parameters based on said available connection configuration parameters, and any of:
performance parameters achieved by said connection configuration parameters related to said prior connection between said UE and said telecommunication network, load situation at different carriers, and
present geographical information of said UE and geographical information of said UE during said prior connection between said UE and said telecommunication network.

30. The method of claim 22, wherein said telecommunication network comprises any of an Evolved Packets System (EPS) network, a Universal Mobile Telecommunications System (UMTS) network, a General Packet Radio Service (GPRS) network, a Global System for Mobile Communications (GSM) network, and a Long Term Evolution (LTE) network.

31. A method of requesting reconnection, by a User Equipment (UE), to a telecommunication network via an access node comprised in said network, wherein said UE is connected to said access node by set connection configuration parameters, said method comprising:
upon detection, by said UE, of a released connection between said UE and said telecommunication network via said access node, storing, by said UE, said connection configuration parameters in relation to said access node; and
requesting, by said UE, reconnection to said telecommunication network via said access node by providing, by said UE, said access node with said stored connection configuration parameters.

32. The method of claim 31, wherein said connection configuration parameters comprises any of:
frequency carrier aggregation configuration via licensed and unlicensed frequency bands;
dual connectivity configuration;
antenna beam configuration;
uplink timing configuration;
history of need for and utilization of secondary carriers;
geographical information
aggregated frequency bands;
aggregated bandwidth, and
measurement and feedback configuration.

33. An access node arranged for connecting user equipment (UE) to a telecommunication network, said telecommunication network comprising said access node, said access node comprising:
a receiver configured to receive a connection request from a User Equipment (UE); and
a processor and memory, the memory comprising instructions executable by the processor, whereby the access node is configured to:
determine equipment arranged for determining connection configuration parameters for said UE, at least by checking whether connection configuration parameters for said UE related to a prior connection between said UE and said telecommunication are available for re-use;
connect said UE to said telecommunication network by setting said determined connection configuration parameters.

34. The access node of claim 33, wherein the memory comprises further instructions such that the access node is configured to:
detect a released connection between said UE and said telecommunication network, and
store said connection configuration parameters in said memory, upon detecting of a released connection between said UE and said telecommunication network, such that said connection configuration parameters are available, for re-use, when said access node receives a further connection request from said UE.

35. The access node of claim 34 wherein the memory comprises further instructions such that the access node is configured to forward said connection configuration parameters to a control node comprised in said telecommunication network for storing said connection configuration in relation to said access node and said UE in said control node.

36. The access node of claim 34, wherein said connection configuration parameters comprises any of:
frequency carrier aggregation configuration via licensed and unlicensed frequency bands;
dual connectivity configuration;
antenna beam configuration for said access node;
uplink timing configuration;
aggregated frequency bands;
aggregated bandwidth; and
history of need for, and utilization of, secondary frequency carrier configuration.

37. A user Equipment (UE) arranged for requesting reconnection to a telecommunication network via an access node comprised in said network, wherein said UE is connected to said access node by set connection configuration parameters, said UE comprising:
a processor and memory, the memory comprising instructions executable by the processor, whereby the UE is configured to:
detect a released connection between said UE and said telecommunication network via said access node,
store said connection configuration parameters, upon detecting of a released connection between said UE and said telecommunication network, and
request reconnection to said telecommunication network via said access node by providing said access node with said stored connection configuration parameters.

38. The UE of claim 37, wherein said connection configuration parameters comprises any of:
frequency carrier aggregation configuration via licensed and unlicensed frequency bands;
dual connectivity configuration;
antenna beam configuration for said access node;
uplink timing configuration;
aggregated frequency bands;
aggregated bandwidth; an
history of need for, and utilization of, secondary frequency carrier configuration.
